(19) United States
(12) Patent Application Publication
(10) Pub. No.: US 2024/0213567 A1
(43) Pub. Date: Jun. 27, 2024

(54) THERMAL INTERLAYER DEVICE WITH SANDWICH STRUCTURE FOR BATTERY MODULES TO ENHANCE COOLING AND PREVENT THERMAL PROPAGATION

(71) Applicant: GM Global Technology Operations LLC, Detroit, MI (US)

(72) Inventors: Jingyuan LIU, Shanghai (CN); Dewen Kong, Shanghai (CN); Dave G. Rich, Sterling Heights, MI (US); John Christian Kalil, Washington, MI (US); Haijing Liu, Shanghal (CN)

(21) Appl. No.: 18/364,161

(22) Filed: Aug. 2, 2023

(30) Foreign Application Priority Data
Dec. 27, 2022 (CN) 202211681727.1

(51) Int. Cl. H01M 10/653; H01M 10/613; H01M 10/658; H01M 50/204; H01M 50/293; H01M 50/296

(52) U.S. Cl. CPC H01M 10/653; H01M 10/613; H01M 10/658; H01M 50/204; H01M 50/293; H01M 50/296

(57) ABSTRACT

A battery module includes C battery cells, wherein each of the C battery cells comprises a housing and a terminals extending from the housing. T thermal interlayer devices are arranged between adjacent ones of the C battery cells. C and T are integers greater than one. Each of the T thermal interlayer devices comprises a first thermally conducting layer in thermal communication with a first one of the C battery cells, a second thermally conducting layer in thermal communication with a second one of the C battery cells, and a thermally resistant layer arranged between the first thermally conducting layer and the second thermally conducting layer. A cooling manifold is in thermal communication with at least one of the first thermally conducting layer and the second thermally conducting layer.

### CROSS-REFERENCE TO RELATED APPLICATIONS

This application claims the benefit of Chinese Patent Application No. 202211681727.1, filed on Dec. 27, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery modules, and more particularly to cooling systems for battery modules.

Electric vehicles (EVs) such as battery electric vehicles (BEVs), hybrid vehicles, and/or fuel cell vehicles include one or more electric machines and a battery system including one or more battery cells, modules and/or packs. A power control system is used to control charging and/or discharging of the battery system during charging and/or driving. Manufacturers of EVs are pursuing increased power density to increase the range of the EVs. During charging and/or operation of the vehicle, the battery cells experience heating. Cooling and/or other temperature management of the battery modules or cells is performed to prevent overheating.

### SUMMARY

A battery module includes C battery cells, wherein each of the C battery cells comprises a housing and terminals extending from the housing. T thermal interlayer devices are arranged between adjacent ones of the C battery cells. C and T are integers greater than one. Each of the T thermal interlayer devices comprises a first thermally conducting layer in thermal communication with a first one of the C battery cells, a second thermally conducting layer in thermal communication with a second one of the C battery cells, and a thermally resistant layer arranged between the first thermally conducting layer and the second thermally conducting layer. A cooling manifold is in thermal communication with at least one of the first thermally conducting layer and the second thermally conducting layer.

In other features, the cooling manifold is in direct thermal communication with the C battery cells. The T thermal interlayer devices are arranged between adjacent pairs of the C battery cells. The T thermal interlayer devices are arranged between every Nth one of the C battery cells, where N is an integer greater than one. The cooling manifold is arranged along an end of the C battery cells opposite to an end of the C battery cells including the terminals. The cooling manifold is arranged along an end of the C battery cells including the terminals. The first thermally conductive layer, the second thermally conductive layer, and the thermally resistant layer extend fully along side surfaces of the C battery cells. The first thermally conductive layer, the second thermally conductive layer, and the thermally resistant layer extend partially along side surfaces of the C battery cells.

In other features, the first thermally conductive layer and the second thermally conductive layer extend around ends of the C battery cells between the cooling manifold and the ends of the C battery cells. The first thermally conductive layer and the second thermally conductive layer extend around ends of the C battery cells and the terminals of the C battery cells between the cooling manifold and the ends of the C battery cells.

In other features, at least one of the first thermally conductive layer, the second thermally conductive layer, and the thermally resistant layer extends partially along side surfaces of the C battery cells. The first thermally conductive layer and the second thermally conductive layer are made of a material selected from a group consisting of carbon fiber, graphite, metal, steel, thermal conducting polymer, thermal conducting gel, grease, and combinations thereof. The first thermally conductive layer and the second thermally conductive layer have a thickness in a range from 1 mm to 2 cm.

In other features, the thermally resistant layer is made of a material selected from a group consisting of silica, silicon, aerogel, glassy fiber, thermal resisting plastic, thermal resisting polymer, thermal resisting grease, a phase-change material, and combinations thereof. The thermally resistant layer has a thickness in a range from 0.5 mm to 2 cm.

A battery pack comprises M battery modules. Each of the M battery modules comprises a housing and T thermal interlayer devices. M and T are integers greater than one, and wherein each of the T thermal interlayer devices comprises a first thermally conducting layer in thermal communication with a first one of the M battery modules, a second thermally conducting layer in thermal communication with a second one of the M battery modules, and a thermally resistant layer arranged between the first thermally conducting layer and the second thermally conducting layer. A cooling manifold is in thermal communication with at least one of the first thermally conducting layer and the second thermally conducting layer.

In other features, the first thermally conductive layer and the second thermally conductive layer are made of a material selected from a group consisting of carbon fiber, graphite, metal, steel, thermal conducting polymer, thermal conducting gel, grease, and combinations thereof. The first thermally conductive layer and the second thermally conductive layer have a thickness in a range from 1 mm to 2 cm. The thermally resistant layer is made of a material selected from a group consisting of silica, silicon, aerogel, glassy fiber, thermal resisting plastic, thermal resisting polymer, thermal resisting grease, a phase-change material, and combinations thereof. The thermally resistant layer has a thickness in a range from 0.5 mm to 2 cm.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a side view of a battery module including a plurality of battery cells and a cooling manifold;

FIG. 1B is a side view of the battery module of FIG. 1A when one of the battery cells experiences thermal runaway;

FIG. 2A is a side view of an example of a battery module including a plurality of battery cells separated by a thermal conducting layer and a cooling manifold;

FIG. 2B is a side view of the battery module of FIG. 2A during a thermal runaway event;

FIG. 3 is a side view of an example of a battery module including a cooling manifold and a plurality of battery cells separated by thermal interlayer devices including thermally conducting layer and a thermally resistant layer according to the present disclosure;

FIGS. 4A and 4B are side views of an example of a battery module including a cooling manifold and a plurality of battery cells separated by the thermal interlayer devices according to the present disclosure;

FIGS. 5A to 5F are side views of additional examples of battery modules including a cooling manifold and a plurality of battery cells separated by thermal interlayer devices according to the present disclosure;

FIGS. 6 to 9 are functional block diagrams of other examples of battery modules including a cooling manifold and battery cells separated by a thermal interlayer device according to the present disclosure; and

FIG. 10 is a functional block diagram a battery pack including battery modules separated by a thermal interlayer device according to the present disclosure.

In the drawings, reference numbers may be reused to identify similar and/or identical elements.

### DETAILED DESCRIPTION

While the battery cells are described herein in the context of vehicles such as battery electric vehicles and hybrid vehicles, the battery cells can be used in stationary applications and/or in other applications.

Thermal interlayer devices according to the present disclosure are arranged between battery cells of a battery module or between battery modules of a battery pack to reduce thermal propagation. In some examples, the thermal interlayer device includes first and second thermally conducting outer layers that are in contact with adjacent battery cells and a middle layer including a thermally resistant layer.

The first and second thermally conducting outer layers of the thermal interlayer device conduct heat to a cooling manifold when the battery cell is heated. If one of the battery cells is undergoing excessive heating (e.g., a thermal runaway event), the thermally resistant layer of the thermal interlayer device is able to prevent the failing battery cell from spreading heat and igniting neighboring battery cells thereby preventing thermal propagation.

Referring now to FIGS. 1A and 1B, a battery module 100 including a plurality of battery cells 112-1, 112-2, . . . , and 112-C (collectively or individually battery cells 112) (where C is an integer greater than one) and a cooling manifold 118. The battery cells 112-1, 112-2, . . . , and 112-C include terminals 114-1, 114-2, . . . , and 114-C (collectively or individually terminals 114). In FIG. 1B, the battery module 100 of FIG. 1A is shown during a thermal runaway event.

Heating of one of the battery cells causes heating of adjacent battery cells. Due to increased heating of the battery cell, the adjacent battery cells may also overheat and experience a thermal runaway event.

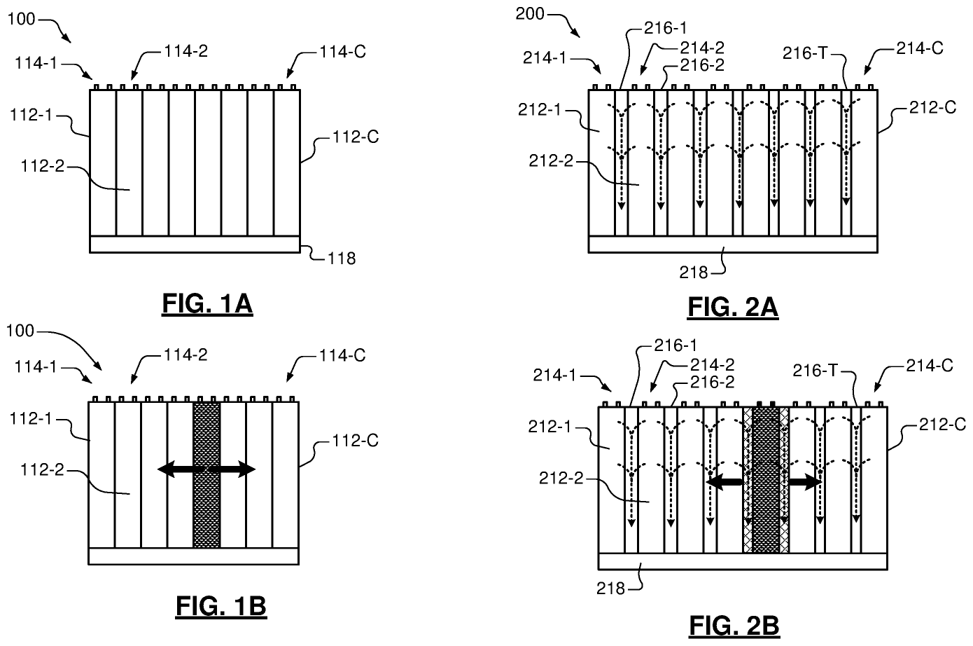

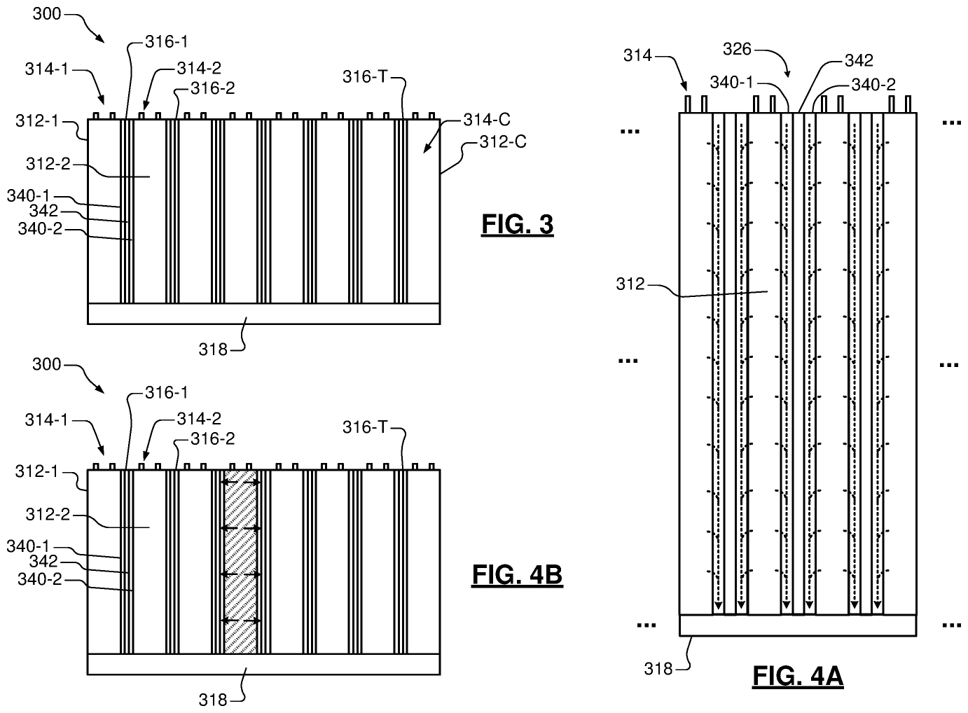

Referring now to FIGS. 2A and 2B, a battery module 200 according to the present disclosure includes a plurality of battery cells 212-1, 212-2, . . . , and 212-C (collectively or individually battery cells 212) (where C is an integer greater than one) and a cooling manifold 218. The battery cells 212-1, 212-2, . . . , and 212-C include external tabs or terminals 214-1, 214-2, . . . , and 214-C (collectively or individually terminals 214). Thermal conducting layers 216-1, 216-2, . . . , and 216-T (where T is an integer greater than one) (collectively or individually thermal conducting layers 216) are arranged between adjacent ones of the plurality of battery cells 212-1, 212-2, . . . , and 212-C.

In FIG. 2B, the battery module 200 of FIG. 2A is shown during a thermal runaway event. Heat from the battery cells is conducted by the thermal conducting layers 216 to the cooling manifold 218. However, the thermal conducting layers 216 does not prevent thermal propagation from a battery cell experiencing thermal runaway to adjacent battery cells.

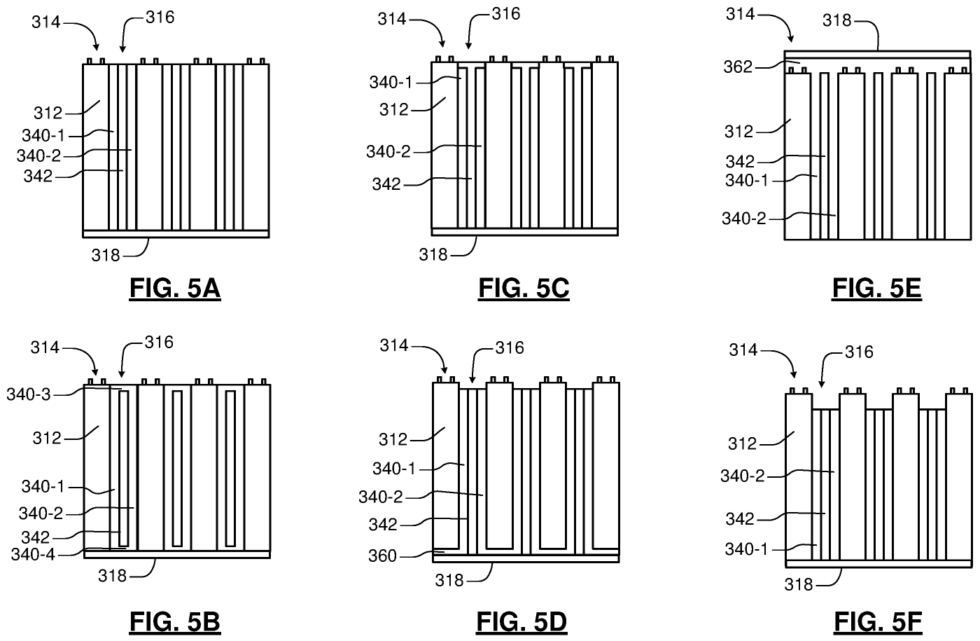

Referring now to FIGS. 3, 4A, and 4B, a battery module 300 includes a cooling manifold 318. A plurality of battery cells 312-1, 312-2, . . . , and 312-C include battery terminals 314-1, 314-2, . . . , and 314-C. The plurality of battery cells 312-1, 312-2, . . . , and 312-C are separated by thermal interlayer devices 316-1, 316-2, . . . , and 316-T (collectively or individually thermal interlayer devices 316). The thermal interlayer devices 316 include first and second thermally conducting layers 340-1 and 340-2 that are in contact with surfaces of adjacent battery cells. A thermally resistant layer 342 of the thermal interlayer devices 316 is arranged between the first and second thermally conducting layers 340-1 and 340-2 and includes a heat resistant material.

In FIGS. 4A and 4B, heat generated by the battery cells 312 is conducted by the thermal interlayer devices to the cooling manifold 318. Heat flows from side surfaces of the battery cells 312 to the first and second thermally conducting layers 340-1 and 340-2. The first and second thermally conducting layers 340-1 and 340-2 conduct the heat to the cooling manifold 318, which acts as a heat sink. Heat generated by one of the battery cells 312 does not flow to adjacent battery cells 312 due to the thermally resistant layer 342.

In other words, the thermally resistant layer 342 in FIGS. 3, 4A and 4B in the middle of the thermal interlayer device prevents heat transported from one battery cell undergoing thermal runaway to adjacent battery cells (as shown by arrows terminating at the thermally resistant layer 342 and travelling vertically as shown in FIG. 4A rather than continuing horizontally to the adjacent battery cells as shown in FIGS. 1B and 2B). As a result, thermal propagation is avoided.

Referring now to FIGS. 5A to 5F, additional examples of battery modules including a cooling manifold and a plurality of battery cells separated by a thermal interlayer devices are shown. In FIG. 5A, the first and second thermally conducting layers 340-1 and 340-2 and the thermally resistant layer 342 extend along the entire height of the battery cells 312. In FIG. 5B, the thermally resistant layer 342 extends along a portion of the battery cell 312. The first and second thermally conducting layers 340-1 and 340-2 extend along the entire height of the battery cells 312 and around ends of the thermally resistant layer 342 (e.g., at 340-3 and 340-4).

In FIG. 5C, the first and second thermally conducting layers 340-1 and 340-2 extend near an upper end of the battery cells 312. The thermally resistant layer 342 is “T”-shaped and extends around upper ends of the first and second thermally conducting layers 340-1 and 340-2.

In FIG. 5D, the first and second thermally conducting layers 340-1 and 340-2 extend around lower ends of the battery cells 312 as shown at 360. The thermally resistant layer 342 is arranged between the first and second thermally conducting layers 340-1 and 340-2. The cooling manifold 318 is arranged below the battery cells 312.

In FIG. 5E, the first and second thermally conducting layers 340-1 and 340-2 extend around upper ends of the battery cells 312 and terminals 314 (e.g., at 362). The thermally resistant layer 342 is arranged between the first and second thermally conducting layers 340-1 and 340-2. The cooling manifold 318 is arranged above the thermally conducting layer 340-1, 340-2, and 362.

In FIG. 5F, the first and second thermally conducting layers 340-1 and 340-2 and the thermally resistant layer 342 do not extend along the entire height of the battery cells 312 and the cooling manifold 318 is arranged below the battery cells 312. In other words, upper ends of the first and second thermally conducting layers 340-1 and 340-2 and the thermally resistant layer 342 are lower than upper ends of the battery cells 312.

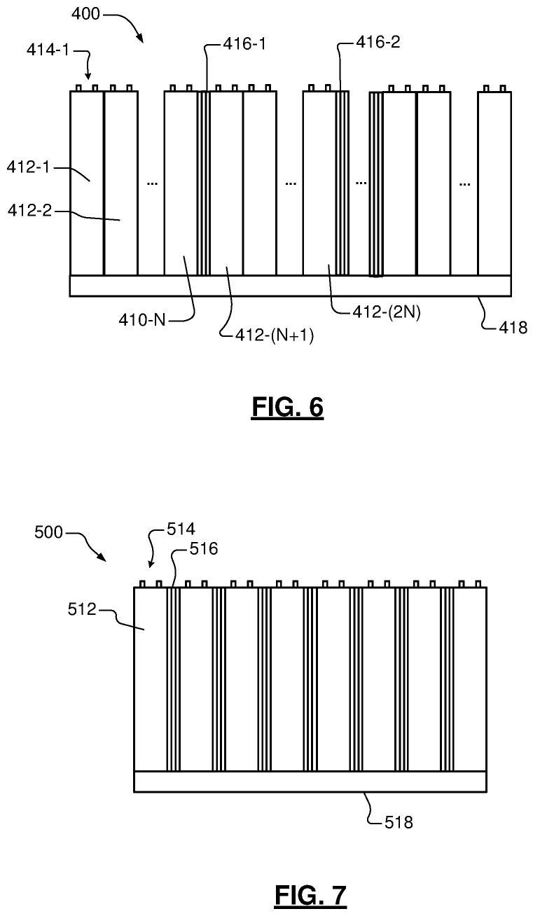

In FIG. 6, a battery module 400 includes a cooling manifold 418 and a plurality of battery cells 412-1, 412-2, . . . , and 412-C including battery terminals 414-1, 414-2, . . . , and 414-C. Thermal interlayer devices 416-1, 416-2, . . . , and 416-T are arranged between every N^{th} one of the battery cells 412, where N is an integer greater than one. Thermal interlayer devices are not arranged between every battery cell.

Referring now to FIGS. 7 to 9, the cooling manifold can be arranged in different configurations. In FIG. 7, a battery module 500 includes battery cells 512, thermal interlayer devices 516, and a cooling manifold 518 arranged along bottom surfaces of the battery cells 512 and the thermal interlayer devices 516. The cooling manifold 518 absorbs heat from the bottom surfaces of the battery cells 512 and ends of the thermal interlayer devices 516.

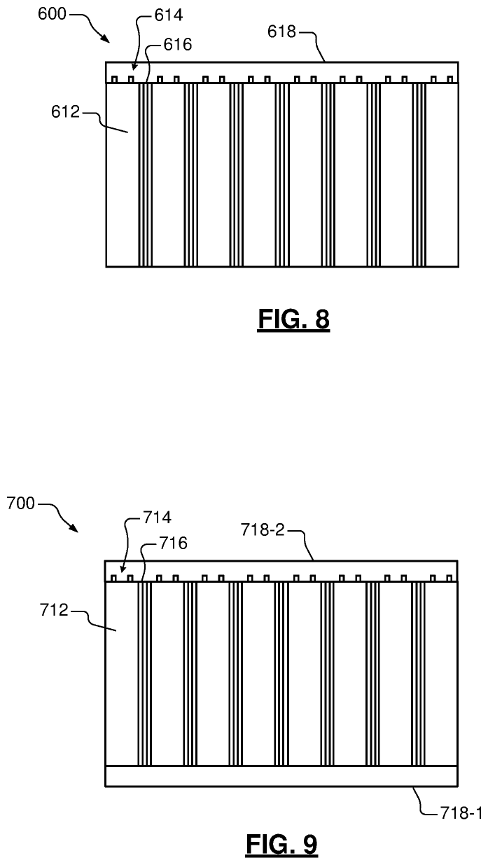

In FIG. 8, a battery module 600 includes battery cells 612, thermal interlayer devices 616, and a cooling manifold 618 arranged along top surfaces of the battery cells 612 and terminals 614 and the thermal interlayer devices 616. The cooling manifold 618 performs cooling of the top surfaces of the battery cells 612, the terminals 614, and upper ends of the thermal interlayer devices 616.

In FIG. 9, a battery module 700 includes battery cells 712, thermal interlayer devices 716, a first cooling manifold 718-1 arranged along bottom surfaces of the battery cells 712 and the thermal interlayer devices 716, and a second cooling manifold 718-2 arranged along top surfaces of the battery cells 712 and terminals 714 and the thermal interlayer devices 716. The first cooling manifold 718-1 absorbs heat from the bottom surfaces of the battery cells 712 and ends of the thermal interlayer devices 716. The second cooling manifold 718-2 performs cooling of the top surfaces of the battery cells 712, the terminals 714, and upper ends of the thermal interlayer devices 716.

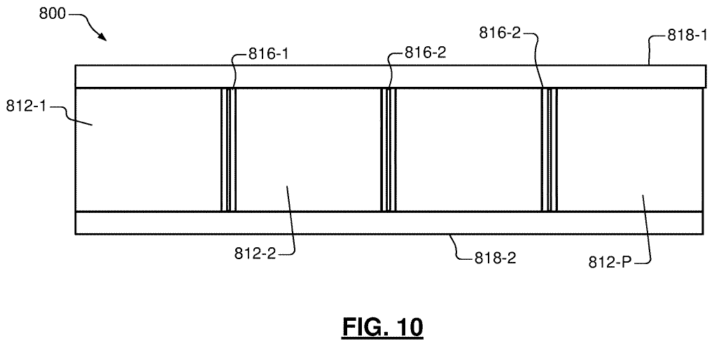

Referring now to FIG. 10, a battery pack 800 includes a plurality of battery modules 812-1, 812-2, . . . , and 812-P. Thermal interlayer devices 816-1, 816-2, . . . , and 816-R are arranged between each of the battery modules 812-1, 812-2, . . . , and 812-P (and/or between every N^{th} one of the battery modules 812-1, 812-2, . . . , and 812-P. Cooling manifolds 818-1 and/or 818-2 can be arranged above and/or below the battery modules 812-1, 812-2, . . . , and 812-P. As can be appreciated, variations described above relating to the cooling manifolds and/or configuration of the thermal interlayer devices can be used.

In some examples, the thermal interlayer device has a total thickness in a range from 1 mm to 2 cm. In some examples, a width and height of the thermal interlayer device is less than corresponding dimensions of the battery cells.

In some examples, the first thermally conductive layer and the second thermally conductive layer are made of a material selected from a group consisting of carbon fiber, graphite, metal, steel, thermal conducting polymer, thermal conducting gel, grease, and combinations thereof. Examples of metal include aluminum, copper, nickel, steel, etc. In some examples, each of the first thermally conductive layer and the second thermally conductive layer has a thickness in a range from 20 μm to 1 cm.

In some examples, the thermally resistant layer is made of a material selected from a group consisting of silica, silicon, aerogel, glassy fiber, thermal resisting plastic, thermal resisting polymer, thermal resisting grease, a phase-change material, and combinations thereof. In some examples, the thermally resistant layer has a thickness in a range from 0.5 mm to 2 cm. In some examples, the thermally resistant layer is also fire resistant.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery module, comprising:
C battery cells, wherein each of the C battery cells comprises a housing and terminals extending from the housing;
T thermal interlayer devices arranged between adjacent ones of the C battery cells, wherein C and T are integers greater than one, and wherein each of the T thermal interlayer devices comprises:
a first thermally conducting layer in thermal communication with a first one of the C battery cells;
a second thermally conducting layer in thermal communication with a second one of the C battery cells; and
a thermally resistant layer arranged between the first thermally conducting layer and the second thermally conducting layer; and
a cooling manifold in thermal communication with at least one of the first thermally conducting layer and the second thermally conducting layer.

2. The battery module of claim 1, wherein the cooling manifold is in direct thermal communication with the C battery cells.

3. The battery module of claim 1, wherein the T thermal interlayer devices are arranged between adjacent pairs of the C battery cells.

4. The battery module of claim 1, wherein the T thermal interlayer devices are arranged between every N^{th} one of the C battery cells, where N is an integer greater than one.

5. The battery module of claim 1, wherein the cooling manifold is arranged along an end of the C battery cells opposite to an end of the C battery cells including the terminals.

6. The battery module of claim 1, wherein the cooling manifold is arranged along an end of the C battery cells including the terminals.

7. The battery module of claim 1, wherein the first thermally conductive layer, the second thermally conductive layer, and the thermally resistant layer extend fully along side surfaces of the C battery cells.

8. The battery module of claim 1, wherein the first thermally conductive layer, the second thermally conductive layer, and the thermally resistant layer extend partially along side surfaces of the C battery cells.

9. The battery module of claim 1, wherein the first thermally conductive layer and the second thermally conductive layer extend around ends of the C battery cells between the cooling manifold and the ends of the C battery cells.

10. The battery module of claim 1, wherein the first thermally conductive layer and the second thermally conductive layer extend around ends of the C battery cells and the terminals of the C battery cells between the cooling manifold and the ends of the C battery cells.

11. The battery module of claim 1, wherein at least one of the first thermally conductive layer, the second thermally conductive layer, and the thermally resistant layer extends partially along side surfaces of the C battery cells.

12. The battery module of claim 1, wherein the first thermally conductive layer and the second thermally conductive layer are made of a material selected from a group consisting of carbon fiber, graphite, metal, steel, thermal conducting polymer, thermal conducting gel, grease, and combinations thereof.

13. The battery module of claim 1, wherein the first thermally conductive layer and the second thermally conductive layer have a thickness in a range from 1 mm to 2 cm.

14. The battery module of claim 1, wherein the thermally resistant layer is made of a material selected from a group consisting of silica, silicon, aerogel, glassy fiber, thermal resisting plastic, thermal resisting polymer, thermal resisting grease, a phase-change material, and combinations thereof.

15. The battery module of claim 1, wherein the thermally resistant layer has a thickness in a range from 0.5 mm to 2 cm.

16. A battery pack, comprising:
M battery modules, wherein each of the M battery modules comprises a housing;
T thermal interlayer devices, wherein M and T are integers greater than one, and wherein each of the T thermal interlayer devices comprises:
a first thermally conducting layer in thermal communication with a first one of the M battery modules;
a second thermally conducting layer in thermal communication with a second one of the M battery modules; and
a thermally resistant layer arranged between the first thermally conducting layer and the second thermally conducting layer; and
a cooling manifold in thermal communication with at least one of the first thermally conducting layer and the second thermally conducting layer.

17. The battery pack of claim 16, wherein the first thermally conductive layer and the second thermally conductive layer are made of a material selected from a group consisting of carbon fiber, graphite, metal, steel, thermal conducting polymer, thermal conducting gel, grease, and combinations thereof.

18. The battery pack of claim 16, wherein the first thermally conductive layer and the second thermally conductive layer have a thickness in a range from 1 mm to 2 cm.

19. The battery pack of claim 16, wherein the thermally resistant layer is made of a material selected from a group consisting of silica, silicon, aerogel, glassy fiber, thermal resisting plastic, thermal resisting polymer, thermal resisting grease, a phase-change material, and combinations thereof.

20. The battery pack of claim 16, wherein the thermally resistant layer has a thickness in a range from 0.5 mm to 2 cm.
